(19) United States
(12) Patent Application Publication
(10) Pub. No.: US 2015/0028749 A1
(43) Pub. Date: Jan. 29, 2015

(54) DRIVING DEVICE FOR DRIVING A LIGHT EMITTING DEVICE WITH STABLE OPTICAL POWER

(71) Applicant: National Chi Nan University, Puli (TW)

(72) Inventors: Tai-Ping SUN, Jhongli City (TW); Hsiu-Li SHIEH, Taichung City (TW); Chi-Neng HO, Puli Township (TW)

(73) Assignee: National Chi Nan University, Puli (TW)

(21) Appl. No.: 14/072,961

(22) Filed: Nov. 6, 2013

(30) Foreign Application Priority Data
Jul. 26, 2013 (TW) 102126922

(51) Int. Cl. H05B 33/08

(52) U.S. Cl. CPC H05B 33/0842
USPC 315/151; 315/307

(57) ABSTRACT

A driving device is adapted to drive a light emitting device with stable optical power, and includes a feedback driving circuit, and a pulse wave generating circuit. The feedback driving circuit provides a driving current that is associated with a pulse-wave signal to the light emitting device, and outputs a feedback signal. The pulse wave generating circuit includes an analog-to-digital converter outputting a digital feedback signal according to the feedback signal, and a controller outputting the pulse-wave signal according to the digital feedback signal.

### CROSS-REFERENCE TO RELATED APPLICATION

This application claims priority to Taiwanese Application No. 102126922, filed on Jul. 26, 2013.

### BACKGROUND OF THE INVENTION

1. Field of the Invention

The invention relates to a driving device, and more particularly to driving device for driving a light emitting device with stable optical power.

2. Description of the Related Art

Light emitting diodes (LEDs) are commonly used for indication, display, decoration, backlight, and lighting due to advantages such as power saving, eco-friendly properties, long service life, small size, fast response, and vibration resistance.

However, optical power of the LEDs may decrease with rise in ambient temperature when driven with a constant current. In addition, the LEDs are continuously heated when driven with a direct-current (DC) driving current, so that the optical power thereof changes more easily due to rise in ambient temperature.

### SUMMARY OF THE INVENTION

Therefore, an object of the present invention is to provide a driving device that may alleviate the above drawbacks of the prior art.

According the present invention, a driving device is adapted to drive a light emitting device with stable optical power. The light emitting device has a forward voltage when driven with current. The forward voltage has an inverse relationship with an ambient temperature. The driving device comprises:

a feedback driving circuit to be coupled to the light emitting device, disposed to receive a pulse-wave signal, and configured to provide a driving current to the light emitting device, and to output a feedback signal, the driving current being a pulse wave in magnitude and having an average magnitude proportional to a duty cycle of the pulse-wave signal; and

a pulse wave generating circuit including:
an analog-to-digital (A/D) converter coupled to the feedback driving circuit for receiving the feedback signal, and configured to output a digital feedback signal according to the feedback signal; and
a controller coupled to the A/D converter for receiving the digital feedback signal, and configured to output the pulse-wave signal according to the digital feedback signal.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram showing a first preferred embodiment of a driving device according to the present invention;

FIG. 2 is a block diagram showing a second preferred embodiment of the driving device according to the pre sent invention;

FIG. 3 is a schematic circuit diagram showing a current control driving module of the second preferred embodiment;

FIG. 4 is a schematic circuit diagram showing a current-control feedback driving module of the second preferred embodiment; and

FIG. 5 is a schematic circuit diagram showing an electrical-power-control feedback driving module of the second preferred embodiment.

### DETAILED DESCRIPTION OF THE PREFERRED EMBODIMENTS

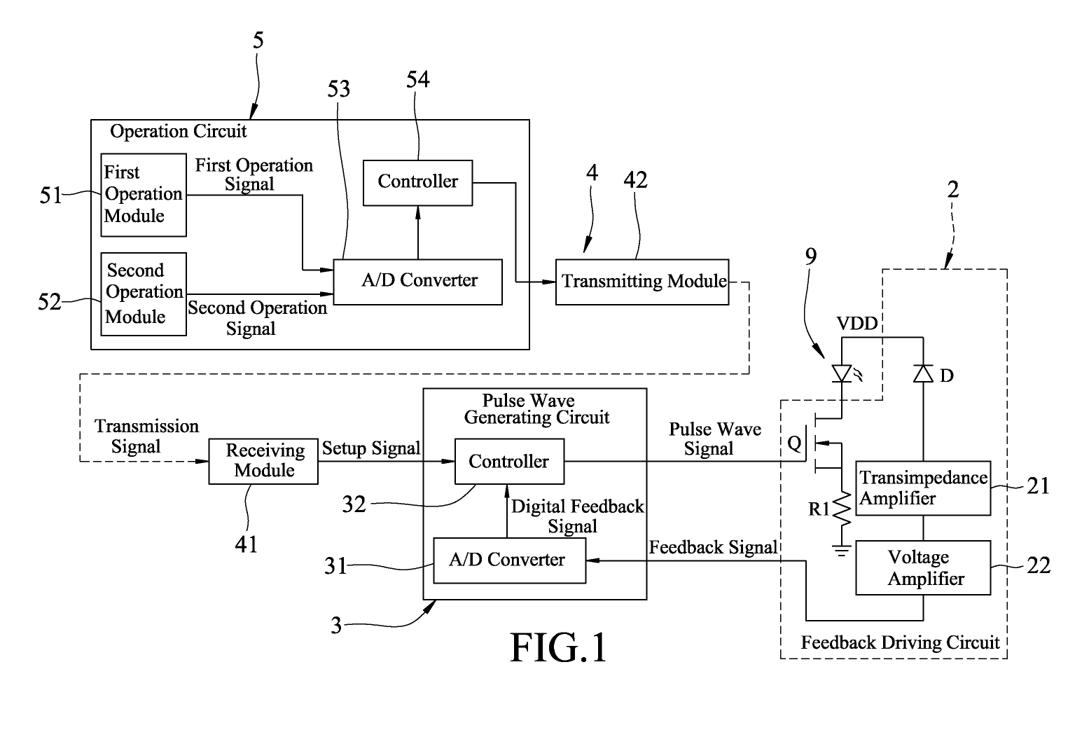

Referring to FIG. 1, the first preferred embodiment of the driving device according to this invention is adapted to drive three light emitting devices 9 with stable optical power, and only one of the light emitting devices 9 is shown therein for the sake of clarity. Each of the light emitting devices 9 has a forward voltage having an inverse relationship with an ambient temperature when driven with current.

The driving device comprises three feedback driving circuits 2 that correspond respectively to the light emitting devices 9, a pulse wave generating circuit 3, a wireless communication circuit 4, and an operation circuit 5. FIG. 1 shows only one feedback driving circuit 2 for the sake of clarity.

In this embodiment, the light emitting devices 9 are light emitting diodes (LEDs) that respectively emit red light, green light, and blue light for cooperatively generating a variety of colors. Other embodiments may include only one feedback driving circuit 2 and a white LED, or a number of various feedback driving circuits 2 and LEDs 9 as required.

Referring to FIG. 1, the feedback driving circuit 2 is coupled to the light emitting device 9, receives a pulse-wave signal, provides a driving current to the light emitting device 9, and outputs a feedback signal. The driving current is a pulse wave in magnitude and has an average magnitude proportional to a duty cycle of the pulse-wave signal.

The feedback driving circuit 2 includes a photodetector (e.g., a photodiode) D, a transimpedance amplifier 21, a voltage amplifier 22, a switch Q, and a resistor R1.

The photodetector D has a cathode coupled to a first voltage source VDD, and an anode, detects optical power of the light emitting device 9, and generates a photocurrent according to the optical power of the light emitting device 9 detected thereby.

The transimpedance amplifier 21 is coupled to the anode of the photodetector D for receiving the photocurrent, and converts the photocurrent into a voltage output.

The voltage amplifier 22 is coupled to the transimpedance amplifier 21 for receiving the voltage output, and amplifies the voltage output for obtaining the feedback signal that is provided to the pulse wave generating circuit 3.

The switch Q has a first terminal coupled to a cathode of the light emitting device 9, a second terminal, and a control terminal coupled to the pulse wave generating circuit 3 for receiving the pulse-wave signal, and is controlled by the pulse-wave signal to make or break electrical connection.

The resistor R1 is coupled between the second terminal of the switch Q and a second voltage source. In this embodiment, the second voltage source is a ground node, but should not be limited thereto.

The pulse wave generating circuit 3 includes an analog-to-digital (A/D) converter 31 and a controller 32.

The A/D converter 31 is coupled to the voltage amplifier 22 for receiving and converting the feedback signal into a digital feedback signal.

The controller 32 is coupled to the A/D converter 31 for receiving the digital feedback signal, and to the control terminal of the switch Q, and outputs to the switch Q the pulse-wave signal according to the digital feedback signal.

The wireless communication circuit 4 includes a receiving module 41 coupled to the controller 32, and a transmitting module 42.

The transmitting module 42 is controlled by the operation circuit 5 to transmit a transmission signal according to user operation of the operation circuit 5.

The receiving module 41 is coupled to the controller 32, wirelessly receives the transmission signal, and outputs to the controller 32 a setup signal corresponding to the transmission signal. In this embodiment, the controller 32 outputs the pulse-wave signal according to the setup signal and the digital feedback signal.

In this embodiment, the wireless communication circuit 4 conforms with a ZigBee wireless communication protocol, and may be configured to use other appropriate wireless communication techniques in other embodiments.

The operation circuit 5 is coupled to the transmitting module 42, is operable by a user to control the transmitting module 42 to transmit the transmission signal, and includes a first operation module 51, a second operation module 52, an A/D converter 53, and a controller 54.

The first operation module 51 is operable by the user for outputting a first operation signal.

The second operation module 52 is operable by the user for outputting a second operation signal.

The A/D converter 53 is coupled to the first and second operation modules 51, 52 for receiving and converting respectively the first and second operation signals into a digitized first operation signal and a digitized second operation signal.

The controller 54 is coupled to the A/D converter 53 for receiving the digitized first and second operation signals, and controls the transmitting module 42 to transmit the transmission signal corresponding to the digitized first and second operation signals.

In this embodiment, the first operation signal is associated with a power setting of the light emitting devices 9, and the second operation signal is associated with a color setting of light to be emitted by the light emitting devices 9. In other embodiment, according to actual requirements, the number of the operation signals may be different, and may be associated with different settings.

In common use, users may set the desired power and color of mixed light emitted by the light emitting devices 9 through the operation circuit 5, and the settings are transmitted to the controller 32 via the transmitting module 42 and the receiving module 41. The controller 32 outputs respectively to the feedback driving circuits 2 the pulse-wave signals that correspond to the power and color settings for respectively controlling the switches Q to make or break electrical connections, so that the light emitting devices 9 emit lights according to the settings.

In this embodiment, the controller 32 adjusts the duty cycles of the pulse-wave signals that respectively correspond to the light emitting devices 9 according to the power and color settings after receiving the setup signal corresponding to the first and second operation signals. The driving current of each of the light emitting devices 9 is thus changed since the average magnitude of the driving current is proportional to the duty cycle of the pulse-wave signal, and optical power of each light emitting device 9 is thus changed to meet the power and color settings since the optical power of the light emitting device 9 is proportional to the average magnitude of the driving current.

When the light emitting device 9 emits light, the photodetector D generates the photocurrent according to the optical power detected thereby, and the A/D converter 31 outputs the corresponding digital feedback signal to the controller 32 after the photocurrent is sequentially processed by the transimpedance amplifier 21, the voltage amplifier 22, and the A/D converter 31. Then, the controller 32 outputs the pulse-wave signal according to the digital feedback signal and a built-in program. In practice, variation of the ambient temperature may result in promotion/reduction of the optical power for each of the light emitting devices 9, leading to color variation of the mixed light resulting from the light emitting devices 9. By virtue of real-time detection of the photodetector D, and adjustment of the pulse-wave signal by the controller 32 according to the feedback signal, optical power and color performance of the light emitting devices 9 may be automatically stabilized.

In detail, when optical power of the light emitting device 9 drops due to rise in the ambient temperature, the photocurrent decreases, resulting in a decreasing voltage output. The controller 32 receives the digital feedback signal that corresponds to the decreasing voltage output, and increases the duty cycle of the pulse-wave signal accordingly, so as to meet the optical power setting. In contrast, when optical power of the light emitting device 9 increases due to decrease in the ambient temperature, the controller 32 receives the digital feedback signal that corresponds to an increasing voltage output, and decreases the duty cycle of the pulse-wave signal accordingly, so as to meet the optical power setting.

To conclude, the first preferred embodiment has the following advantages:

1. By virtue of the feedback driving circuit 2, optical power of the light emitting device 9 may be automatically compensated, thus being substantially non-varying with the ambient temperature or time.

2. By virtue of the pulse-wave generating circuit 3 that controls the feedback driving circuit 2 using the pulse-wave signal, this embodiment is advantageous in terms of power-saving, easier control of light mixing, and better heat dissipation when compared to the analog-type direct current driving. In addition, the controller 32 is advantageous in being programmable, which facilitates correction of the correlated color temperature (CCT) or the color rendering index (CRI), thereby enhancing flexibility in use.

3. Wireless communication between the operation circuit 5 and the pulse wave generating circuit 3 enhances flexibility in use. Since ZigBee is characterized by low speed, low power consumption, low cost, support of a large number of nodes on a network, low complexity, good signal reliability, highly safe, and being suitable for large-scale environmental measurements, applications may be widely expanded to medical inspection, lighting, display, indication, optical access systems, etc.

4. By virtue of the first and second operation modules 51, 52 that correspond respectively to the power and color settings, it is convenient for a user to set desired power and color of mixed light emitted by the light emitting devices 9. By cooperation with feedback control of the feedback driving circuit 2, optical power and the color may be automatically restored to meet the optical power and color settings.

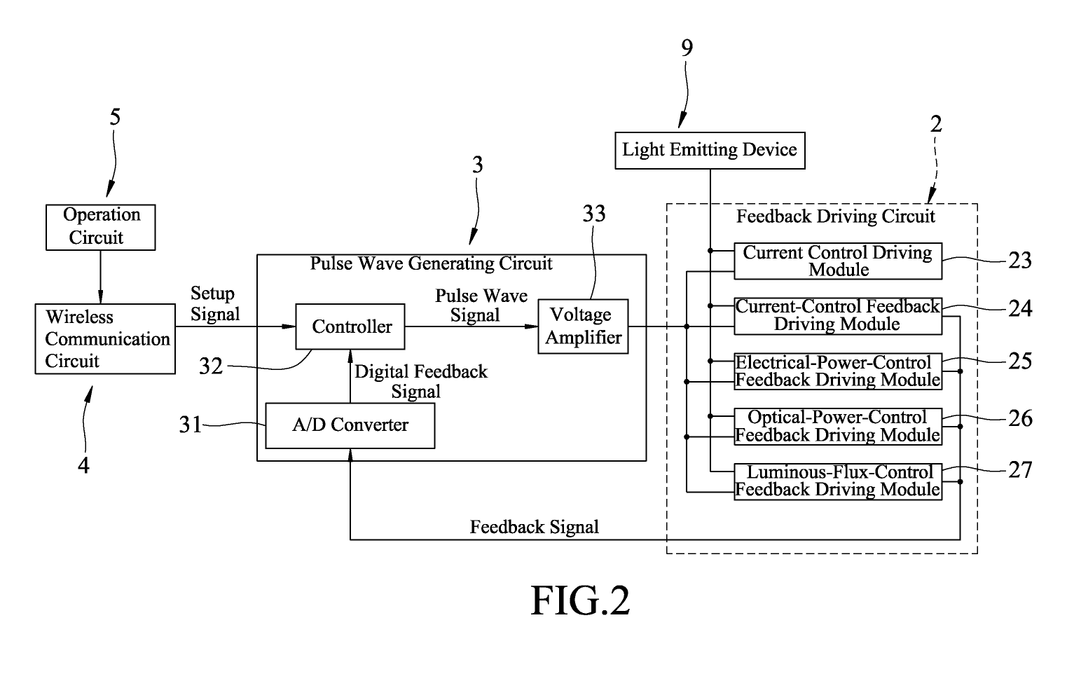

Referring to FIG. 2, the second preferred embodiment of the driving device according to the present invention differs from the first preferred embodiment in the following aspects:

The pulse-wave generating circuit 3 further includes a voltage amplifier 33 coupled to the controller 32 for receiving and amplifying the pulse-wave signal outputted by the controller 32.

The feedback driving circuit 2 includes a current control driving module 23, a current-control feedback driving module 24, an electrical-power-control feedback driving module 25, an optical-power-control feedback driving module 26, and a luminous-flux-control feedback driving module 27, which receive and convert the amplified pulse-wave signal into the driving current provided to the light emitting device 9. The driving current is provided to the light emitting device 9, is a pulse wave in magnitude, and has an average magnitude proportional to the duty cycle of the pulse-wave signal.

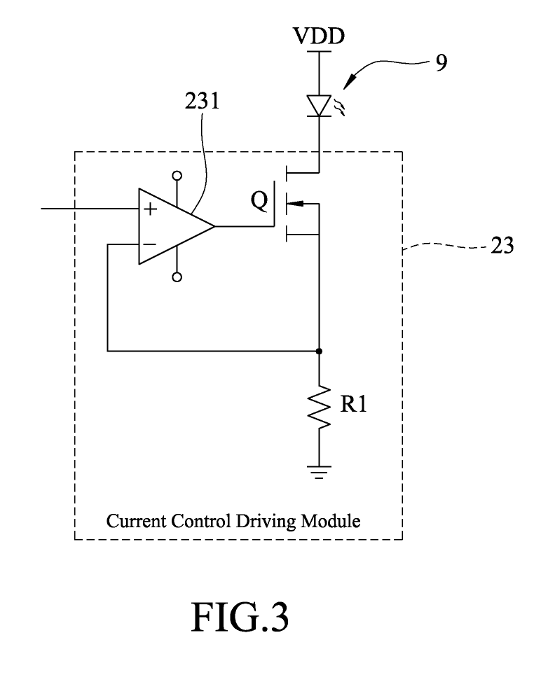

Referring to FIGS. 2 and 3, the current control driving module 23 includes an operational amplifier 231, a switch Q, and a resistor R1.

The operational amplifier 231 has a first input (non-inverting input) coupled to the voltage amplifier 33 for receiving the amplified pulse-wave signal, a second input (inverting input), and an output for outputting a control signal corresponding to the amplified pulse-wave signal.

The switch Q has a first terminal coupled to the cathode of the light emitting device 9, a second terminal coupled to the second input of the operational amplifier 231, and a control terminal coupled to the output of the operational amplifier 231 for receiving the control signal, and is controlled by the control signal to make or break electrical connection, resulting in provision of the driving current to the light emitting device 9.

The resistor R1 is coupled between the second terminal of the switch Q and the second voltage source.

Since the pulse-wave signal outputted by the controller 32 generally has a peak voltage of 5V, this embodiment uses a voltage amplifier 33 coupled between the controller 32 and the feedback driving circuit 2 for promoting the driving current provided to the light emitting device 9. The voltage amplifier 33 is implemented using a non-inverting amplifier circuit, but should not be limited thereto.

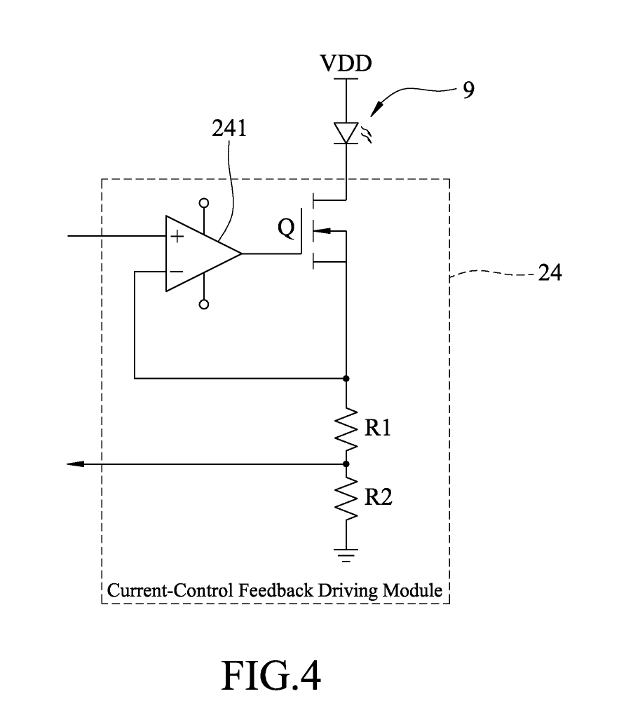

Referring to FIGS. 2 and 4, the current-control feedback driving module 24 is similar to the current control driving module 23, and differs in that the current-control feedback driving module 24 further includes a resistor R2 coupled between the resistor R1 and the second voltage source, and outputs the feedback signal at a common node of the resistor R1 and the resistor R2. The feedback signal is a voltage signal associated with the driving current.

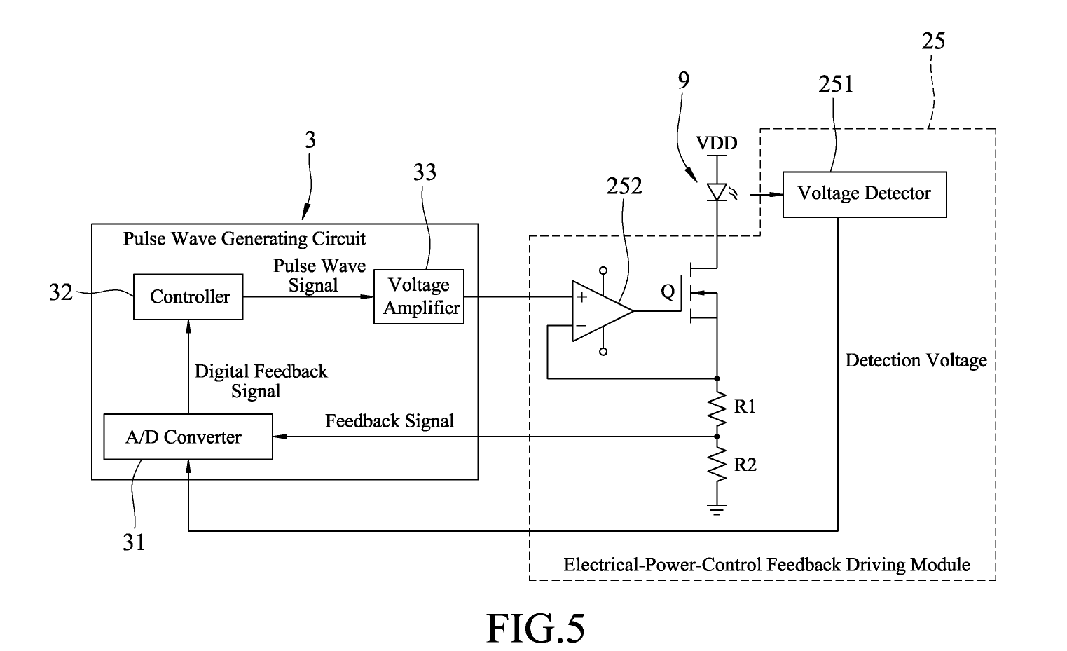

Referring to FIGS. 2 and 5, the electrical-power-control feedback driving module 25 is similar to the current-control feedback driving module 24, and differs in that the electrical-power-control feedback driving module 25 further includes a voltage detector 251. The voltage detector 251 is coupled across the light emitting device 9 for detecting the forward voltage of the light emitting device 9, and outputs a detection voltage corresponding to the forward voltage. The A/D converter 31 is coupled to the voltage detector 251 for receiving the detection voltage, and outputs the digital feedback signal according to the detection voltage and the feedback signal that is received from the common node of the resistors R1, R2.

In addition, both of the optical-power-control feedback driving module 26 and the luminous-flux-control feedback driving module 27 have the same circuit configuration as the electrical-power-control feedback driving module 25 in this embodiment, and details thereof are not repeated herein for the sake of brevity.

In this embodiment, the controller 32 of the pulse-wave generating circuit 3 has built-in programs associated with current control driving operation, current-control feedback driving operation, electrical-power-control feedback driving operation, optical-power-control feedback driving operation, and luminous-flux-control feedback driving operation, and users may select a module from the driving modules 23-27 and a corresponding program as required.

Referring to FIGS. 2 and 4, when the current-control feedback driving module 24 is selected, the controller 32 is first configured to output under the room temperature the pulse-wave signal conforming with a duty cycle set by the user, and the resulting feedback signal (i.e., the voltage at the common node of the resistors R1, R2) is recorded to serve as a comparison base. When the ambient temperature changes, the voltage of the feedback signal changes accordingly. According to the program associated with the current-control feedback driving operation, the controller 32 decreases/increases the duty cycle of the pulse-wave signal when the voltage of the feedback signal becomes higher/lower, until the voltage becomes equal to the comparison base.

Referring to FIGS. 2 and 5, when the electrical-power-control feedback driving module 25 is selected, the controller 32 is first configured to output under the room temperature the pulse-wave signal conforming with the duty cycle set by the user, and a product of the resulting feedback signal (i.e., the voltage at the common node of the resistors R1, R2) and the detection voltage (corresponding to the forward voltage of the light emitting device 9) is recorded to serve as a comparison base. When the ambient temperature changes, the voltage of the feedback signal changes accordingly, resulting in change of the product. According to the program associated with the electrical-power-control feedback operation, the controller 32 decreases/increases the duty cycle of the pulse-wave signal when the product becomes greater/smaller, until the product becomes equal to the comparison base.

When the optical-power-control feedback driving module 26 is selected, a relationship between ambient temperature and efficiency of conversion from electrical power to optical power of the light emitting device 9 (i.e., electro-optic conversion efficiency) must be obtained. Such a relationship may be obtained by acquiring a relationship between the ambient temperature and the optical power under a known electrical power. In addition, the current ambient temperature may be obtained by measuring the detection voltage that corresponds to the forward voltage of the light emitting device 9 since the forward voltage varies with the ambient temperature. According to the program associated with the optical-power-control feedback driving operation, after computing the current ambient temperature according to the detection voltage corresponding to the digital feedback signal, the controller 32 may adjust the duty cycle of the pulse-wave signal according to the current ambient temperature and the relationship between ambient temperature and electro-optic conversion efficiency, so as to maintain substantially a product of the duty cycle of the pulse-wave signal and the electro-optic conversion efficiency.

When the luminous-flux-control feedback driving module 27 is selected, a relationship between ambient temperature and efficiency of conversion from electrical power to luminous flux (i.e., a ratio between the electrical power and the luminous flux) of the light emitting device 9 must be obtained. Such a relationship may be obtained by acquiring a relationship between the ambient temperature and the luminous flux under a known electrical power. As mentioned above, the current ambient temperature may be obtained by measuring the detection voltage. According to the program associated with the luminous-flux-control feedback driving operation, after computing the current ambient temperature according to the detection voltage corresponding to the digital feedback signal, the controller 32 may adjust the duty cycle of the pulse-wave signal according to the current ambient temperature and the relationship between ambient temperature and ratio between the electrical power and the luminous flux, so as to maintain substantially a product of the duty cycle of the pulse-wave signal and the ratio between the electrical power and the luminous flux.

Therefore, the second preferred embodiment may achieve the same purpose and effects as the first preferred embodiment. Furthermore, by virtue of the current control driving module 23, the current-control feedback driving module 24, the electrical-power-control feedback driving module 25, the optical-power-control feedback driving module 26, the luminous-flux-control feedback driving module 27, and the corresponding programs built in the controller 32, the user may select one of the driving modules 23-27 for stabilizing optical power of the light emitting device 9 as required.

To sum up, the present invention is advantageous not only in terms of stabilization of optical power, power saving, easy control of light mixing, and good heat dissipation, but also in wireless control to enhance flexibility in use.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A driving device adapted to drive a light emitting device with stable optical power, the light emitting device having a forward voltage when driven with current, the forward voltage having an inverse relationship with an ambient temperature, said driving device comprising:
a feedback driving circuit to be coupled to the light emitting device, disposed to receive a pulse-wave signal, and configured to provide a driving current to the light emitting device, and to output a feedback signal, the driving current being a pulse wave in magnitude and having an average magnitude proportional to a duty cycle of the pulse-wave signal; and
a pulse wave generating circuit including:
an analog-to-digital (A/D) converter coupled to said feedback driving circuit for receiving the feedback signal, and configured to output a digital feedback signal according to the feedback signal; and
a controller coupled to said A/D converter for receiving the digital feedback signal, and configured to output the pulse-wave signal according to the digital feedback signal.

2. The driving device as claimed in claim 1, further comprising:
an operation circuit operable by a user; and
a wireless communication circuit including:
a transmitting module that is controlled by said operation circuit to transmit a transmission signal according to user operation of said operation circuit; and
a receiving module coupled to said pulse wave generating circuit, and configured to wirelessly receive the transmission signal transmitted by said transmitting module, and to output to said controller of said pulse wave generating circuit a setup signal corresponding to the transmission signal;
wherein said controller of said pulse wave generating circuit outputs the pulse-wave signal according to the setup signal and the digital feedback signal.

3. The driving device as claimed in claim 2, wherein said operation circuit includes:
a first operation module operable by the user for outputting a first operation signal;
an A/D converter coupled to said first operation module for receiving the first operation signal, and configured to convert the first operation signal into a digitized first operation signal; and
a controller coupled to said A/D converter of said operation circuit for receiving the digitized first operation signal, and configured to control said transmitting module to transmit the transmission signal corresponding to the digitized first operation signal.

4. The driving device as claimed in claim 3, wherein the first operation signal is associated with a power setting of the light emitting device;
said operation circuit further includes a second operation module operable by the user for outputting a second operation signal associated with a color setting of light to be emitted by the light emitting device;
said A/D converter of said operation circuit is further coupled to said second operation module for receiving the second operation signal, and is further configured to convert the second operation signal into a digitized second operation signal; and
said controller further receives the digitized second operation signal from said A/D converter of said operation circuit, and controls said transmitting module to transmit the transmission signal corresponding to the digitized first operation signal and the digitized second operation signal.

5. The driving device as claimed in claim 2, wherein said wireless communication circuit conforms with a ZigBee wireless communication protocol.

6. The driving device as claimed in claim 1, wherein said feedback driving circuit includes:
a photodetector to be coupled to a first voltage source, disposed to detect optical power of the light emitting device, and configured to generate a photocurrent according to the optical power of the light emitting device detected thereby;
a transimpedance amplifier coupled to said photodetector for receiving the photocurrent, and configured to convert the photocurrent into a voltage output;
a voltage amplifier coupled to said transimpedance amplifier for receiving the voltage output, and configured to amplify the voltage output for obtaining the feedback signal that is provided to said pulse wave generating circuit; and
a switch and a resistor to be coupled to the light emitting device in series, a circuit connection formed by the light emitting device, said switch and said resistor to be coupled between the first voltage source and a second voltage source, said switch being coupled to said controller of said pulse wave generating circuit, and being controlled by the pulse-wave signal to make or break electrical connection.

7. The driving device as claimed in claim 1, wherein said pulse wave generating circuit further includes a voltage amplifier coupled to said controller for receiving the pulse-wave signal, and configured to amplify the pulse-wave signal;
wherein said feedback driving circuit includes a current control driving module including:
an operational amplifier that has a first input coupled to said voltage amplifier for receiving the amplified pulse-wave signal, a second input, and an output for outputting a control signal corresponding to the amplified pulse-wave signal;
a switch having a first terminal, a second terminal coupled to said second input of said operational amplifier, and a control terminal coupled to said output of said operational amplifier for receiving the control signal; and
a resistor;
wherein said switch and said resistor are to be coupled to the light emitting device in series, a circuit connection formed by the light emitting device, said switch and said resistor to be coupled between a first voltage source and a second voltage source; and
said switch is controlled by the control signal to make or break electrical connection, resulting in provision of the driving current to the light emitting device.

8. The driving device as claimed in claim 1, wherein said pulse wave generating circuit further includes a voltage amplifier coupled to said controller for receiving the pulse-wave signal, and configured to amplify the pulse-wave signal;
wherein said feedback driving circuit includes a current-control feedback driving module including:
an operational amplifier that has a first input coupled to said voltage amplifier for receiving the amplified pulse-wave signal, a second input, and an output for outputting a control signal corresponding to the amplified pulse-wave signal;
a switch having a first terminal, a second terminal coupled to said second input of said operational amplifier, and a control terminal coupled to said output of said operational amplifier for receiving the control signal; and
a first resistor and a second resistor coupled in series;
wherein said switch, said first resistor and said second resistor are to be coupled to the light emitting device in series, a circuit connection formed by the light emitting device, said switch, said first resistor and said second resistor to be coupled between a first voltage source and a second voltage source;
said switch is controlled by the control signal to make or break electrical connection, resulting in provision of the driving current to the light emitting device; and
the feedback signal is outputted at a common node of said first resistor and said second resistor and is a voltage signal associated with the driving current.

9. The driving device as claimed in claim 1, wherein said pulse wave generating circuit further includes a voltage amplifier coupled to said controller for receiving the pulse-wave signal, and configured to amplify the pulse-wave signal;
wherein said feedback driving circuit includes an electrical-power-control feedback driving module including:
a voltage detector to be coupled across the light emitting device for detecting the forward voltage of the light emitting device, and configured to output a detection voltage corresponding to the forward voltage;
an operational amplifier that has a first input coupled to said voltage amplifier for receiving the amplified pulse-wave signal, a second input, and an output for outputting a control signal corresponding to the amplified pulse-wave signal;
a switch having a first terminal, a second terminal coupled to said second input of said operational amplifier, and a control terminal coupled to said output of said operational amplifier for receiving the control signal; and
a first resistor and a second resistor coupled in series;
wherein said switch, said first resistor and said second resistor are to be coupled to the light emitting device in series, a circuit connection formed by the light emitting device, said switch, said first resistor and said second resistor to be coupled between a first voltage source and a second voltage source;
said switch is controlled by the control signal to make or break electrical connection, resulting in provision of the driving current to the light emitting device;
the feedback signal is outputted at a common node of said first resistor and said second resistor and is a voltage signal associated with the driving current; and
wherein said A/D converter is coupled to said voltage detector and the common node of said first resistor and said second resistor for receiving respectively the detection voltage and the feedback signal, and outputs the digital feedback signal according to the detection voltage and the feedback signal.

10. The driving device as claimed in claim 1, wherein said feedback driving circuit includes an optical-power-control feedback driving module configured to output the feedback signal that is a voltage associated with the driving current, and a detection voltage associated with the forward voltage of the light emitting device;
said A/D converter is coupled to said optical-power-control feedback driving module for receiving the detection voltage and the feedback signal, and outputs the digital feedback signal according to the detection voltage and the feedback signal; and
said controller is further configured to compute a current ambient temperature according to the detection voltage corresponding to the digital feedback signal, and to adjust the duty cycle of the pulse-wave signal according to the current ambient temperature and a relationship between ambient temperature and efficiency of conversion from electrical power to optical power of the light emitting device, so as to maintain substantially a product of the duty cycle of the pulse-wave signal and the efficiency of conversion from electrical power to optical power of the light emitting device.

11. The driving device as claimed in claim 1, wherein:
said feedback driving circuit includes a luminous-flux control feedback driving module configured to output the feedback signal that is a voltage associated with the driving current, and a detection voltage associated with the forward voltage of the light emitting device;
said A/D converter is coupled to said luminous-flux-control feedback driving module for receiving the detection voltage and the feedback signal, and is configured to output the digital feedback signal according to the detection voltage and the feedback signal; and
said controller is further configured to compute a current ambient temperature according to the detection voltage corresponding to the digital feedback signal, and to adjust the duty cycle of the pulse-wave signal according to the current ambient temperature and a relationship between ambient temperature and efficiency of conversion from electrical power to luminous flux of the light emitting device, so as to maintain substantially a product of the duty cycle of the pulse-wave signal and the efficiency of conversion from electrical power to luminous flux of the light emitting device.
